(19) United States
(12) Patent Application Publication
(10) Pub. No.: US 2013/0240643 A1
(43) Pub. Date: Sep. 19, 2013

(54) IRRIGATION SETUP AND A METHOD OF DEFINING THE SAME

(71) Applicant: Hassan KHATEB, Golan Heights (IL)

(72) Inventor: Hassan KHATEB, Golan Heights (IL)

(73) Assignee: NaanDanJain Irrigation Ltd., Kibbutz Na'an (IL)

(21) Appl. No.: 13/800,665

(22) Filed: Mar. 13, 2013

Related U.S. Application Data
(60) Provisional application No. 61/610,168, filed on Mar. 13, 2012.
(60) Provisional application No. 61/644,496, filed on May 9, 2012.

(51) Int. Cl. B05B 12/02

(52) U.S. Cl. CPC B05B 12/02
USPC 239/589; 708/446

(57) ABSTRACT

A method for determining irrigation time across an area with a predetermined size S and based on desired precipitation quantity Q and precipitation rate P. The irrigation setup has a fluid output LPH≧S*P. The new irrigation time T_{NEW} is defined as T_{NEW}=Q/P_{DRY}. P_{DRY} is a representative sampling precipitation average based on an indicative percentage PR of lowermost precipitation measurements selected out of a plurality of precipitation measurements taken across the area S.

### FIELD OF THE SUBJECT MATTER OF THE PRESENT APPLICATION

This disclosed subject matter relates to methods of defining an irrigation setup.

### BACKGROUND OF THE SUBJECT MATTER OF THE PRESENT APPLICATION

In the field of irrigation, when it is desired to irrigate an area of predetermined size, it is known to use various evaluation parameters of irrigation such as Coefficient of Uniformity (CU), Distribution Uniformity (DU) and Scheduled Coefficient (SC).

In essence the above parameters provide the user with data regarding the distribution of precipitation over a given area under a predetermined irrigation setup and allow him to determine whether the selected setup in field (sprinkler properties, distance between sprinklers and between laterals) is sufficient for its desired purpose. These parameters also give an indication to the user on how to modify the irrigation setup and regime (time, spread etc.) in order to achieve desired irrigation requirements.

The (CU) and (DU) are indicators only. However, the (SC) parameter is an indicator but also gives an option of fixing precipitation for dry areas of the irrigated area by increasing irrigation time.

The above adjustment is usually required since irrigation means, specifically sprinklers, are provided with standard discrete irrigation output values (measured in Liters Per Hour—LPH), these values not always corresponding with the predetermined size of the area and desired precipitation rate (also referred to as flow rate).

According to common practice, the user is first required to determine the sprinkler with the minimal fluid output LPH value which will meet his desired irrigation requirements such as precipitation quantity Q and precipitation rate P. For this purpose, an initial fluid output LPH′ is first calculated as follows: LPH′=S*P, where S is the area in m² and P is the minimum required precipitation rate in mm/hr. Thereafter, a sprinkler is chosen with the minimal fluid output LPH exceeding the value of LPH′.

The irrigation time T using the sprinkler is determined based on the required precipitation quantity Q and the desired precipitation rate P. For example, if the user requires an overall precipitation Q=60 mm over the irrigated area with a precipitation rate of P=4 mm/hr, the irrigation time T will be equal to 60ₘₘ/4_{mm/hr}=15 hours.

For example, for an area of 120 m² (S=120), a desired precipitation quantity of 30 mm and a desired precipitation rate of 3 mm/hr (P=3), the value of LPH′ is 120*3=360LPH, and the required time is T=30ₘₘ/3_{mm/hr}=10 hr. Thus, the user knows that, theoretically, he is required to use a sprinkler having a 360LPH for ten hours.

However, given sprinklers have discrete values, e.g. 350, 400, 450 and 500 LPH, and so there may not be an available sprinkler having an LPH of 360 as theoretically required. Therefore, the sprinkler with the minimal fluid output value exceeding LPH′ will be chosen, in this case, 400LPH (i.e. the sprinkler with 350LPH will not suffice as 350/120=2.916 . . . ≦P).

Once the appropriate sprinkler is chosen, an average precipitation rate P′ is determined as follows: P′=LPH/S. In the present example, P′=400/120=3.33 mm/hr.

It is appreciated that P′ represents the average precipitation rate, and so across the entire predetermined area S there exist over-irrigated areas in which the precipitation rate is P′_{HIGH}≧P′ and under-irrigated areas (hereinafter: dry zones) in which the precipitation rate is P′_{LOW}≦P′. Thus, if the irrigation time is set to T, the over-irrigated areas will receive a precipitation quantity Q_{OVER}=P′_{HIGH}*T>P′*T and the dry zones will receive a precipitation quantity Q_{UNDER}=P′_{LOW}*T<P′*T.

In order to provide the necessary addition of precipitation to the dry zones, a percentage PR indicator is first chosen for which the addition will be calculated. For example, PR=10% denotes all the zones across the area in which the precipitation measurements are in the 10% lowesmost measurements.

In practice, in order to determine P_{DRY}, for a given number of precipitation measurements taken across the area, the percentage PR will denote a number of the lowermost precipitation measurements taken. For example, per the above, PR=10% denotes, in practice, 1/10^{th} of the total measurements taken, having the lowest precipitation. Given, for example, 200 measurements, PR=10% will denote the 20 lowermost precipitation measurements across the entire area, based on which, a low average precipitation P_{DRY} can be calculate (average of these 20 measurements).

The measurement data based on which P_{DRY} is derived either from actual measurements taken across the area or a portion thereof, or from a previous measurement database applicable for the given parameters. Measurements can either be taken across the entire area (for example a grid of measurement means), or be taken for a portion of the area and thereafter performing an interpolation for the entire area.

It is important to note that the value of P_{DRY} is provided either by physical measurement of precipitation across the above area or by computer software and/or user manuals which provide a distribution of precipitation values across the area based on the distribution of sprinklers thereon. For example, for a value P′=3.33 mm/hr and PR chosen as 6%, the value of P_{DRY} can be P_{DRY}=2.775.

The above mentioned SC parameters can then be defined as the ratio between P′ and P_{DRY}→SC=P′/P_{DRY}. In the present example, SC=3.33/2.775=1.2. The parameter SC indicates to the user that an irrigation time T would not provide the dry zones with the required irrigation quantity and therefore should be increased by an additional 20% yielding a new irrigation time T′>T (1 equals 100% thus 1.2 equals 120%) to achieve the desires precipitation across the irrigated area. In the present example, T′=T*SC=10 hr*1.2=12 hr.

The final formula for deriving the new irrigation time can thus be denoted as:

T′=(LPH*Q)/(P*P_{DRY}*S)

Once the irrigation time is adjusted according to the SC, the previously determined dry zones will now be provided with the required precipitation corresponding to P′. Consequently, the original average precipitation rate P′ will now be increased to P″.

Further, in practice, it is common that if SC greater than 1.3, changes are required in at least one of the following: irrigation means, positioning of the irrigation means across the area etc. in order to reduce this parameter.

### SUMMARY OF THE SUBJECT MATTER OF THE PRESENT APPLICATION

The presently disclosed subject matter calls for a method of evaluation of irrigation parameters based on desired irrigation parameters to be achieved.

In particular, in accordance with one aspect of the disclosed subject matter, there is provided a method for defining an irrigation setup for a predetermined area based on desired initial irrigation parameters (e.g. precipitation rate P, precipitation quantity Q and irrigation time T), and for modifying the irrigation time T to a new irrigation time T_{NEW} of the setup by a derivation based on the chosen irrigation arrangement and the initial irrigation parameters.

According to the subject matter of the present application there is provided a method for determining irrigation time across an area with a predetermined size S, based on desired precipitation quantity Q and precipitation rate P;
wherein the irrigation setup has a fluid output LPH≧S*P;
wherein the new irrigation time T_{NEW} is defined as follows: T_{NEW}=Q/P_{DRY}; and
wherein P_{DRY} is a representative sampling precipitation average based on an indicative percentage PR of lowermost precipitation measurements selected out of a plurality of precipitation measurements taken across the area S.

Specifically, there is provided a method for evaluation of irrigation across an area with a predetermined size S, said method including the steps of:
a) providing a desired precipitation quantity Q and a desired precipitation rate P across the above area;
b) determining the desired irrigation time T based on Q and P so that T=Q/P;
c) determining an initial fluid output LPH′ following LPH′=S*P;
d) choosing an irrigation arrangement with a minimal fluid output LPH exceeding LPH′;
e) obtaining measurement data of the chosen irrigation arrangement with a fluid output LPH;
f) choosing a percentage indicator PR;
g) obtaining P_{DRY} based on the chosen PR and the measurement data;
h) defining an improved Real Schedule Coefficient (RSC) parameter following RSC=P/P_{DRY}; and
i) determining an updated time T_{NEW}≠T following T_{NEW}=T*RSC.

Thus, the final formula for deriving the new irrigation time T′ under the method of the present application can be denoted simply as: T_{NEW}=Q/P_{DRY} thereby considerably simplifying the method.

It particular, it is observed that the re-evaluation of the irrigation time T to T_{NEW} avoids the use of the average precipitation rate P′ at all and uses only the desired precipitation quantity Q and the measured P_{DRY}.

The above method also provides for substantial saving of irrigation fluid when adjusting the irrigation arrangement. In particular, it is appreciated that the commonly used parameter of SC allows adjusting the precipitation rate of the dry areas to the precipitation rate P′ which is determined by the irrigation arrangement, and is usually greater or equal to the required precipitation rate P.

As a result of adjusting the irrigation arrangement according to a higher precipitation rate P′, much irrigation fluid is simply wasted. In addition, for crops which are sensitive to an excessive amount of precipitation, increasing the precipitation rate can cause damage to the crops (yield, quality etc.).

In addition, since the above method yields an RSC which is usually lower than the common SC parameter, it allows utilizing positioning arrays of irrigation arrangement (e.g. sprinklers, sprayers, foggers and the like, including arrays thereof) which would otherwise be rejected by the user. Specifically, if the original SC is greater than 1.3, the positioning array would be rejected. To the contrary, under the present method, RSC may be lower than 1.3 for the same positioning array, therefore making usable.

### DETAILED DESCRIPTION OF EMBODIMENTS

With reference to the method previously disclosed in the background of the subject matter of the present application, the following parameters are used:

| Indicator | Function | Units |
|---|---|---|
| S | The irrigated area | m² |
| Q | Precipitation quantity | mm |
| P | Precipitation rate | mm/hr |
| T | Irrigation time | hr |
| LPH′ | Ideal irrigation fluid output → LPH′ = S * P | l/hr |
| LPH | Actual irrigation fluid output (chosen from given | l/hr |
| | values of irrigation setups) | |
| PR | Dry zone percentage - represents the selected % | % |
| | of the lowest measurements taken with the actual | |
| | irrigation fluid output | |
| P_{DRY} | An average precipitation of the selected % | mm/hr |
| | lowest measurements | |

The steps of the method are performed as follows (exemplary values being the same as those used in the background):
i. an area is given of S=120 m²;
ii. choosing a desired precipitation quantity Q, for example, 30 mm and a desired precipitation rate, for example, P=3 mm/hr;
iii. determining an initial irrigation time T as T=Q/P=30ₘₘ/3_{mm/hr}=10 hr;
iv. defining LPH′ by LPH′=S*P=120*3=360LPH;
v. choosing a sprinkler having a fluid output LPH>LPH′, for example,
LPH=400 (a sprinkler with LPH=350 will not suffice);
vi. obtaining measurement data including N measurements across the area S applicable for the above given parameters;
vii. choosing a percentage indicator PR, for example PR=10%;
viii. obtaining the average precipitation for the dry area P_{DRY} based on applying PR to given measurements, as an average of the lowermost 10% of the measurements. For example, for measurement data having N=50 measurements, calculating an average of the five lowermost measurements: e.g. 2.75, 2.765, 2.77, 2.78, 2.81 (exemplary data). P_{DRY}=(2.75+2.765+2.77+2.78+2.81)/5=2.775. It is noted that all of the five values are below 3 mm/hr;
ix. defining an improved parameter RSC by RSC=P/P_{DRY}=3/2.775=1.081; and
x. Determining an updated irrigation time T_{NEW} as T_{NEW}=T*RSC=10 hr*1.081=10.81 hr.

The formula for T_{NEW} can also be simplified to T_{NEW}=Q/P_{DRY} and so T_{NEW}=30/2.775=10.81 hr.

It is appreciated that compared to the commonly used method for defining the SC parameter which yields SC=1.2, i.e. an addition of 20% to the irrigation time (i.e. T′=12 hr), the presently described method yields an addition of only 8.1%, i.e. T_{NEW}=10.81 hr. In other words, compared to the commonly used method, the present method allows saving approx. 10% of irrigation fluid, wasted during the additional 1.19 hrs of irrigation time.

In some cases, if the SC parameter is 1.3 and more it is not acceptable. In such a case, designers cancel the sprinkler or the spacing means and chose another sprinkler or use the same sprinkler however install more sprinklers by decreasing the distance between sprinklers or between laterals. The presently described method allows avoiding modifying the irrigation setup and simply changing the irrigation time.

For comparison, the following table is given for a different case having different measurement data (but with the same requirements):

| | Common practice | Method of the present app. |
|---|---|---|
| S (given) | 120 m² | 120 m² |
| P (desired) | 3 mm/hr | 3 mm/hr |
| Q (desired) | 30 mm | 30 mm |
| T (calculated) | Q/P = 30/3 = 10 hr | Q/P = 30/3 = 10 hr |
| LPH′ (calculated) | S * P = 120 * 3 = 360 | S * P = 120 * 3 = 360 |
| LPH (chosen) | LPH ≧ LPH′ → 400 ≧ 360 | LPH ≧ LPH′ → 400 ≧ 360 |
| P′ (calculated) | LPH/S = 400/120 = 3.33 mm/hr | — |
| PR (desired) | 10% | 10% |
| P_{DRY} (measured) | 2.5 | 2.5 |
| SC/RSC (calculated) | SC = P′/P_{DRY} = 3.33/2.5 = 1.332 | RSC = P/P_{DRY} = 3/2.5 = 1.2 |
| T′/T_{NEW} (calculated) | T′ = T * SC = 10 hr * 1.332 = 13.32 hr | T_{NEW} = T * RSC = 10 hr * 1.2 = 12 hr |
| T′/T_{NEW} (calculated) | T′ = (LPH * Q)/(P * P_{DRY} * S) = | T_{NEW} = Q/P_{DRY} = 30/2.5 = 12 hr |
| | (400 * 30)/(3 * 2.5 * 120) = 13.32 hr | |

In the above case, the same sprinklers used in the same positioning array across the areas would be rejected by the common practice (since SC>1.3) whereas under the presently disclosed method, it would be perfectly usable (RSC=1.2<1.3).

It is appreciated that, in principle, SC≧RSC. However, the two values RSC and SC can be equal to one another in case the required precipitation rate is equal to the precipitation rate of the used sprinkler.

In practice, it is noted that common software/calculating means allow the user to input the irrigation arrangement (i.e. the actual fluid output LPH), the spread of the irrigation arrangement over the irrigated area and the desired PR parameter. In other words, once these parameters have been provided to a software/calculating means, all the calculations are performed with respect to the calculated average precipitation rate P′, including the SC parameter.

To the contrary, according to the method of the disclosed subject matter, the software/calculating means allow inputting the desired precipitation rate P initially required by the user and thereby calculating the updated RSC parameter.

Those skilled in the art to which this invention pertains will readily appreciate that numerous changes, variations, and modification can be made without departing from the scope of the invention, mutatis mutandis.

1. A method for determining irrigation time across an area with a predetermined size S, based on desired precipitation quantity Q and precipitation rate P;
wherein the irrigation setup has a fluid output LPH≧S*P;
wherein the new irrigation time T_{NEW} is defined as follows: T_{NEW}=Q/P_{DRY}; and
wherein P_{DRY} is a representative sampling precipitation average based on an indicative percentage PR of lowermost precipitation measurements selected out of a plurality of precipitation measurements taken across the area S.

2. A method for determining irrigation time across an area with a predetermined size S, said method including the steps of:
providing a desired precipitation quantity Q and a desired precipitation rate P across the above area;
determining a desired irrigation time T=Q/P;
determining an initial fluid output LPH′=S*P;
choosing, from a variety of available irrigation arrangements, an irrigation arrangement with a minimal fluid output LPH≧LPH′;
obtaining a plurality N of measurements across the area S including;
choosing a percentage indicator PR (%);
obtaining P_{DRY} as the PR (%) of lowest values of the N measurement;
defining an improved Real Schedule Coefficient RSC=P/P_{DRY}; and
determining an updated time T_{NEW}=T*RSC.

3. The method according to claim 2, wherein the updated time T_{NEW} is T′=Q/P_{DRY}.

4. The method according to claim 3, wherein the Real Schedule Coefficient RSC≦1.3.

5. An irrigation setup for irrigating an area with a predetermined size S, said irrigation setup being configured for providing at least a precipitation quantity Q and a precipitation rate P and comprising at least one irrigation device having a fluid output LPH≧S*P and an irrigation time T_{NEW}=Q/P_{DRY}, wherein P_{DRY} is a representative sampling precipitation average based on an indicative percentage PR of lowermost precipitation measurements selected out of a plurality of precipitation measurements taken across the area S.

6. The irrigation setup according to claim 5, wherein said irrigation device is a sprinkler.

7. The irrigation setup according to claim 6, wherein said irrigation setup comprises a plurality of irrigation devices arranged in an array.

8. The method according to claim 1, wherein the updated time T_{NEW} is T′=Q/P_{DRY}.

9. The method according to claim 2, wherein the Real Schedule Coefficient RSC≦1.3.

10. The method according to claim 2, wherein the Real Schedule Coefficient RSC≦1.25.

11. The method according to claim 2, wherein the Real Schedule Coefficient RSC≦1.2.

12. The method according to claim 3, wherein the Real Schedule Coefficient RSC≦1.25.

13. The method according to claim 3, wherein the Real Schedule Coefficient RSC≦1.2.
